(19) United States
(12) Patent Application Publication
(10) Pub. No.: US 2005/0133526 A1
(43) Pub. Date: Jun. 23, 2005

(54) Mounting structure for viscous liquid dispenser

(76) Inventors: Richard Paul Lewis, Marietta, GA (US); Holly Lynn Prokash, Alpharetta, GA (US); Cleary Efton Mahaffey, Appleton, WI (US)

Correspondence Address: KIMBERLY-CLARK WORLDWIDE, INC., 401 NORTH LAKE STREET, NEENAH, WI, 54956, US

(21) Appl. No.: 10/745,783

(22) Filed: Dec. 23, 2003

(51) Int. Cl. B67D 5/06

(52) U.S. Cl. 222/1; 222/181.3

(57) ABSTRACT

A mounting bracket for a liquid dispenser is provided. The bracket includes a two-position locking mechanism. The locking mechanism includes a locking member slidingly engaged within the bracket. The locking member is capable of sliding to a first position at which an end portion of the locking member interferes with removal of the dispenser from the mounting bracket. Additionally, the locking member is capable of sliding to a second position at which the dispenser may be removed from the mounting bracket. The locking mechanism provides protection against removal by unauthorized persons, but allows easy removal by maintenance personnel.

### BACKGROUND OF THE INVENTION

Various configurations and models of liquid dispensers, particularly liquid soap dispensers, are well known in the art. Some conventional dispensers typically employed in public restrooms and the like are wall mounted units that typically include a housing or structure that is not permanently affixed to a wall. This may be because it may be advantageous for maintenance personnel to fully replace an empty dispenser housing with a new housing that contains both the replacement liquid as well as a self-contained dispensing pump. However, these disposable dispensers can be susceptible to being stolen. Therefore, there is a need for a wall-mounted dispenser that is difficult to remove for unauthorized persons, but easily removed by maintenance personnel.

The present invention is an improvement over existing systems in that it provides a mounting bracket for a disposable self-contained dispenser that provides protection against removal by unauthorized persons, but allows easy removal by maintenance personnel.

### SUMMARY OF THE INVENTION

Advantages of the invention will be set forth in part in the following description, or may be obvious from the description, or may be learned through practice of the invention.

In accordance with one embodiment of the present invention, a mounting bracket for mounting a liquid dispenser housing to a wall is disclosed. The mounting bracket includes a plate member that includes a first substantially vertical side wall and a second substantially vertical side wall. Each substantially vertical side wall includes at least one angled surface for engaging against complementary angled surfaces on the liquid dispenser housing. The bracket further includes a two-position locking mechanism. The locking mechanism includes a locking member slidingly engaged within at least one opening defined within the plate member. The locking member is capable of sliding to a first position at which an end portion of the locking member extends beyond the first vertical side wall to interfere with removal of the liquid dispenser housing from the mounting bracket. Additionally, the locking member is capable of sliding to a second position at which the liquid dispenser housing may be removed from the mounting bracket. Optionally, the end portion of the locking member may include a chamfered surface. The chamfered surface is angled to allow the locking member to slide to the second position during installation of the dispenser.

In one aspect, the locking member may include a pin. The pin may include a first portion extending substantially parallel to the second vertical side wall. Further, the pin may include a second portion extending substantially perpendicular to the second vertical side wall. Alternatively, the pin may include a second portion extending at an angle with respect to the second vertical side wall.

In a further aspect, the locking member may, for example, include a ferrous material or a magnet, or may be magnetically activated.

In an even further aspect, the mounting bracket may include a means for urging the locking member towards the first position. As one example, the means for urging may include a spring.

In another aspect, the mounting bracket may include a pinion rotatably attached to a surface of the plate member. The pinion includes a first end having a first set of circumferential angled threads engaged to at least one tooth on a surface of the locking member. Rotation of the pinion in a first direction slides the locking member toward the first position, while rotation of the pinion in a second direction slides the locking member toward the second position. The pinion may be rotatably supported within a bushing attached to a surface of the plate member.

Optionally, the mounting bracket may include a second locking member. The second locking member may include at least one tooth engaged to a second set of circumferential angled threads upon a second end of the pinion. Rotation of the pinion in the first direction slides the locking members away from one another to lock the dispenser housing to the mounting bracket. Rotation of the pinion in the second opposite direction slides the locking members towards each other to unlock the dispenser housing from the mounting bracket.

In accordance with another embodiment of the present invention, a self contained viscous liquid dispenser is disclosed that includes a housing, an internal liquid reservoir defined by the housing, a dispensing pump mechanism disposed at least partially within the reservoir and having a delivery end extending out of the reservoir, and a mounting mechanism configured as an integral component of the housing. The mounting mechanism includes angled surfaces detachably connectable with a complementary mounting structure on a wall surface. The complementary mounting structure includes a plate member and a two-position locking mechanism including a locking member slidingly engaged within at least one opening defined within the plate member. The plate member includes a first substantially vertical side wall and a second substantially vertical side wall. Each substantially vertical side wall includes at least one angled surface for engaging against the complementary angled surfaces on the liquid dispenser housing. The locking member is capable of sliding to a first position at which an end portion of the locking member extends beyond the first vertical side wall to interfere with removal of the liquid dispenser housing from the mounting structure. Additionally, the locking member is capable of sliding to a second position at which the liquid dispenser housing may be removed from the mounting structure.

In one aspect, the housing is slidable in a generally vertical direction onto the mounting structure. The angled surfaces slide into engagement with the complementary angled surfaces on the mounting structure such that the housing cannot be pulled away from the mounting structure.

In accordance with still another embodiment of the present invention, a disposable viscous liquid dispenser is disclosed that includes a housing defining an internal integral liquid reservoir, a dispensing pump mechanism disposed at least partially within the reservoir and including an operable delivery end for dispensing the viscous liquid from the housing, and a back side configured for placement against a supporting wall surface. The back side includes a mounting mechanism formed integral therewith. The mounting mechanism includes engagement surfaces configured to releasably interlock with complementary structure of a wall mounting member provided on a supporting wall so that the housing cannot be pulled away from the supporting wall. The wall mounting member includes a locking member slidingly positioned within at least one track defined within the wall mounting member, a means for resiliently biasing the sliding locking member towards a locking position at which the locking member substantially prevents removal of the housing from the wall mounting member, and a means for moving the sliding locking member towards a position at which the sliding locking member will not prevent the removal or installation of the housing.

In accordance with an even further embodiment of the present invention a disposable liquid soap dispenser is disclosed that includes a housing defining an internal integral liquid soap reservoir and a back side configured for placement against a supporting wall surface, a dispensing pump mechanism disposed at least partially within the reservoir and comprising an operable delivery end for dispensing liquid soap from the housing, and a mounting mechanism formed integral with the back side. The mounting mechanism includes engagement surfaces configured to releasably interlock with complementary structure of a wall mounting member provided on a supporting wall so that the housing cannot be pulled away from the supporting wall. The mounting mechanism further includes a recess defined in the back side. The recess includes at least two vertical side walls having at least one angled surface disposed on each of the vertical side walls. The housing is slidable in a generally vertical direction onto the wall mounting member, the angled surfaces sliding into engagement with complementary angled surfaces on the wall mounting member.

The dispenser further includes a mounting bracket locking mechanism that includes a locking member slidingly engaged by the mounting structure. The locking member is capable of sliding to a locking position at which a portion of the locking member is positioned so as to interfere with removal of the housing from the mounting structure. Additionally, the locking member is capable of sliding to an unlocked position to enable removal of the housing from the mounting structure. In a further aspect, the dispenser may include a protrusion disposed on the back side of the housing. The protrusion is engageable in a complementary divot defined in the wall mounting structure.

In accordance with another embodiment of the present invention, a method of attaching a liquid dispenser to a wall mounting structure is disclosed. The method includes the steps of placing a magnet adjacent a locking mechanism attached to the wall mounting structure to slide a locking member to a central location within the wall mounting structure, engaging the dispenser to the wall mounting structure, and removing the magnet to allow the locking member to slide to a locking location where the locking member restricts removal of the dispenser from the wall mounting structure.

In accordance with still another embodiment of the present invention a method of removing a liquid dispenser from a wall mounting structure is disclosed. The method includes the steps of placing a magnet adjacent a locking mechanism inside the wall mounting structure to deactivate the locking mechanism, and disengaging the dispenser from the wall mounting structure.

The invention will be described in greater detail below with reference to particular embodiments illustrated in the figures.

### BRIEF DESCRIPTION OF THE DRAWINGS

FIG. 1 is a perspective view of a dispenser according to the present invention;

FIG. 2 is a perspective view of the back side of the dispenser illustrated in FIG. 1;

FIG. 3 is an alternative perspective view of the dispenser according to FIG. 1 and complementary wall mounting structure;

FIG. 4 is a cross-sectional view of the dispenser taken along the lines indicated in FIG. 3;

FIG. 5 is a cross-sectional view of the pump mechanism of the dispenser taken along the lines indicated in FIG. 3;

FIG. 6 is a cross-sectional operational view of the pump mechanism;

FIG. 7 is a cross-sectional operational view of the pump mechanism;

FIG. 8a is a partial perspective and cut-away view of the pump mechanism particularly illustrating the locking feature thereof;

FIG. 8b is a partial perspective and cut-away view of the pump mechanism particularly illustrating the locking feature thereof;

FIG. 9 is a perspective partial operational view of a wall mounting bracket having an internal, two-position locking mechanism;

FIG. 10 is a cross-sectional view of the wall mounting bracket taken along the lines indicated in FIG. 9;

FIG. 11 is a partial cross-sectional, partial cut-away, operational view of the wall mounting bracket of FIG. 9;

FIG. 12 is a partial cross-sectional, partial cut-away, operational view of the wall mounting bracket of FIG. 9;

FIG. 13 is a partial cross-sectional, partial cut-away, operational view of another embodiment of the internal, two-position locking mechanism;

FIG. 14 is a partial cross-sectional, partial cut-away, operational view of a further embodiment of the internal, two-position locking mechanism;

FIG. 15 is a perspective view of another embodiment of a wall mounting bracket for mounting the dispenser;

FIG. 16 is a perspective view of a pinion for use with the wall mounting bracket of FIG. 15;

FIG. 17 is a perspective view of a slidable gear rack for use with the wall mounting bracket of FIG. 15;

FIG. 18 is a partial cross-sectional, partial cut-away, operational view of another embodiment of the internal, two-position locking mechanism;

FIG. 19 is a partial cross-sectional, partial cut-away, operational view of the internal, two-position locking mechanism of FIG. 18.

### DETAILED DESCRIPTION

Reference will now be made in detail to embodiments of the invention, one or more examples of which are illustrated in the drawings. Each example is provided by way of explanation of the invention, not meant as a limitation of the invention. For example, features illustrated or described as part of one embodiment, may be used with another embodiment, to yield still a further embodiment. It is intended that the present invention include modifications and variations to the embodiments described herein.

The present invention relates to a locking mounting bracket or wall structure having a two-position locking mechanism for use with any manner of liquid dispenser. The locking mounting bracket is particularly well suited for use with any manner of viscous liquid dispenser, for example soap dispensers, lotion dispensers, and the like. The present invention also encompasses a dispenser utilizing the locking mounting bracket according to the invention. Examples of dispensers that may benefit from the mounting bracket of the present invention are described in WO 02/49490 A1 as well as U.S. Pat. No. 6,516,976 to Lewis et al., U.S. Pat. No. 6,533,145 to Lewis et al., U.S. Pat. No. 6,543,651 to Lewis et al., U.S. Pat. No. 6,575,334 to Lewis et al., and U.S. Pat. No. 6,575,335 to Lewis et al., and U.S. patent application publications 2002/0074354A1 and 2002/0074355A1, the entireties of which are incorporated herein by reference.

A viscous liquid dispenser 10 according to the invention is illustrated generally in the figures. The dispenser 10 is illustrated and described herein as a liquid soap dispenser, which is a particularly useful embodiment of the present invention. However, it should be appreciated that the present invention is not limited to a dispenser for liquid soap, but has application in any environment wherein it is desired to dispense a metered amount of a viscous liquid from a dispensing unit.

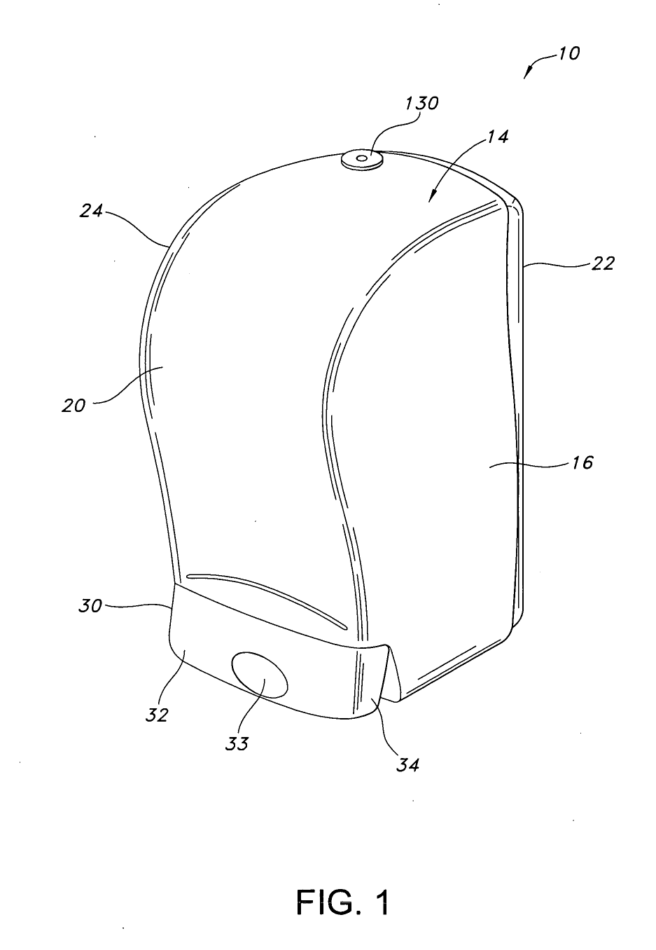

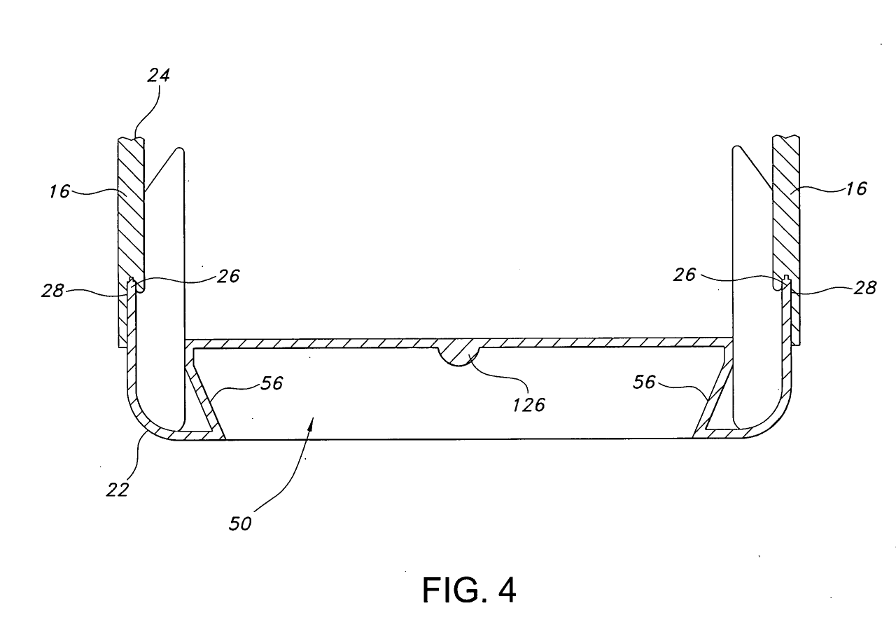

Referring to FIGS. 1-3, the dispenser 10 includes a housing, generally 14. The housing 14 may contain side walls or members 16, a back side 18, and a front side 20. The housing 14 can take on any desired configuration and be formed from any number of components. In the illustrated embodiment, the housing 14 includes a front component 24 and a back component 22. The front and back components are separately manufactured and are permanently joined. It should be appreciated that the components may be manufactured from any desired material. In a desirable embodiment, the dispenser 10 is a disposable item and the housing 14 is molded from a relatively inexpensive plastic material. Referring particularly to FIG. 4, the back component 22 may be molded from a clear or translucent plastic and includes side edges 26. The back component 22 is aligned relative to the front component 24 and the side edges 26 fit into correspondingly sized recesses 28 defined in the side walls 16 of the front component 24. The back component 22 is permanently joined to the front component 24 by adhesives, welding, or any other relatively permanent attaching means.

It may be desired to provide means for a maintenance technician to determine the level of viscous liquid within the dispenser. In this regard, a portion of the housing 14 may be formed from a translucent or clear material. The entire back component 22 may be formed from a translucent or clear material so that the service or maintenance technician can view the remaining liquid level from the side of the dispenser. In an alternative embodiment, a window (not shown) of clear or translucent material may be provide anywhere in the housing 14, desirably near the bottom portion of the housing, to provide the maintenance technician with the capability of viewing inside the reservoir to determine the remaining amount of liquid therein.

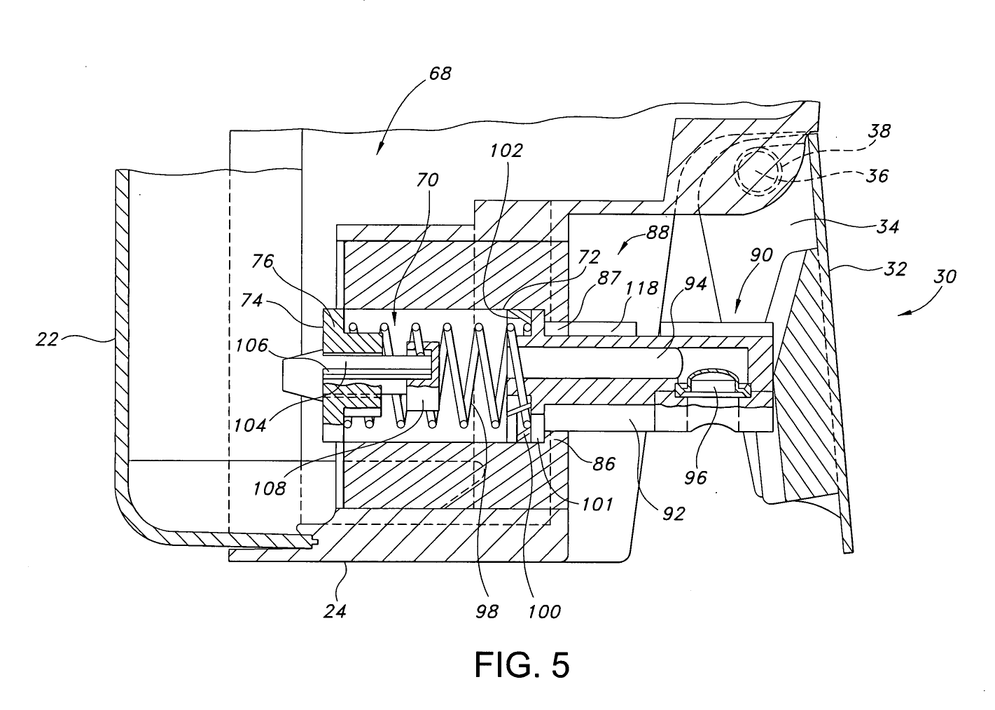

The housing 14 defines an internal liquid reservoir 68 (FIG. 5) within the internal volume thereof. In the illustrated embodiment, the liquid reservoir 68 includes essentially the entire volume defined by the front component 24 and back component 22. Although not illustrated, it should be understood that any number of internal structural members, such as baffles or the like, may be included within the reservoir 68. It should be understood that the housing 14 thus also serves as a closed or sealed reservoir and the dispenser 10 cannot be opened by the maintenance technician. A desired amount of viscous liquid, for example soap, is preloaded into the dispenser 10 prior to the dispenser being delivered to its point of use.

The back component 22 of the housing 14 is desirably more rigid than the front component 24. One way of achieving this feature is to simply mold the back component 22 with a thickness greater than that of the front component 24. As will be explained in greater detail below, the dispenser 10 is mounted onto a supporting wall surface by means of an internal mounting mechanism configured on the back side 18 of the housing 14. A more rigid back component 22 aids in mounting the dispenser 10. It has also been found that, if the front and back components are molded from a resilient plastic material, once the dispenser is empty, the back component 22 has enough “give” to enable the dispenser 10 to be easily removed from the supporting wall structure.

Referring to FIG. 5, a dispensing pump mechanism, generally 88, is disposed at least partially within the reservoir 68. The pump mechanism 88 has a delivery end 90 that extends out of the housing 14 or reservoir 68. The pump mechanism 88 is configured to dispense a metered amount of the viscous fluid upon a user actuating the pump mechanism. It should be appreciated that any number of conventional and well known pump devices may be utilized in the dispenser 10. The pump mechanism 88 illustrated in the drawings is one embodiment of a particularly well suited mechanism. Other desirable pump mechanisms, for example, are disclosed in copending U.S. patent application Ser. No. 10/675,034, filed Sep. 30, 2003, the entirety of which is incorporated herein by reference.

Referring to FIGS. 5 through 7, the pump mechanism 88 includes a cylinder 92 that is slidable within a chamber 70. The volume of chamber 70 determines the metered dose of liquid dispensed upon each actuation of the pump. The chamber 70 may be formed by any internal structure of the housing 14. It may be desirable that the chamber is defined by structure integrally molded with the front component 24 of the housing 14. In the illustrated embodiment, the chamber 70 is defined by chamber walls 72 as a generally cylindrical chamber. The cylinder 92 includes a channel 94 defined longitudinally therethrough. The channel 94 is in communication with the interior of the pump chamber 70 through an end wall of the cylinder. The delivery channel 94 terminates at a dispensing orifice 96 defined in the front end of the cylinder 92.

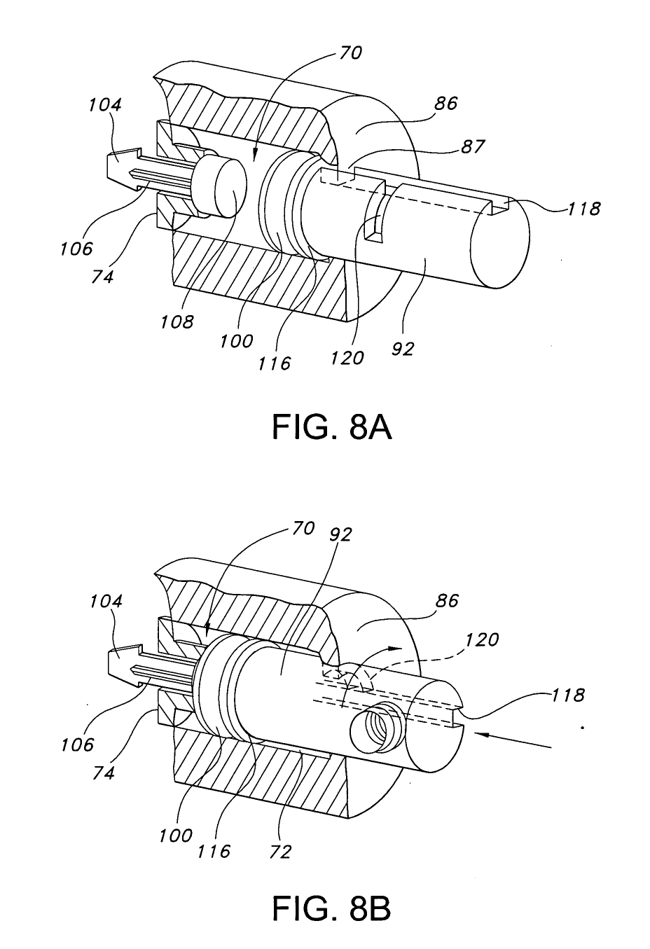

The cylinder 92 sealingly engages against the chamber walls 72 by any conventional means. For example, a flange or piston 101 may be disposed at the rear end of the cylinder 92 for sealing engagement against chamber wall 72. In an alternative embodiment, O-rings 116 (FIG. 8a) may be provided around the piston 101. The piston 101 pressurizes the chamber 70 and ensures that the viscous liquid contained within the chamber is dispensed through the delivery channel 94 upon actuation of the cylinder 92 and does not simply move from one end of the pump chamber 70 to the other upon movement of the cylinder.

The pump cylinder 92 is biased within the chamber 70 by way of, for example, a spring 98. Other resilient devices, including a leaf spring, spring washer, and the like, may be utilized for this purpose. In the illustrated embodiment, the spring 92 is seated within a recess 102 defined by a flared flange 100, as particularly illustrated in FIGS. 5 through 7. The opposite end of the spring 98 is fitted around a cylindrical extension 76 of an end cap 74. The end cap 74 is permanently fixed to the structure defining the pump chamber 70 after the cylinder 92 has been inserted into the pump chamber.

Structure is also provided to ensure that the cylinder 92 cannot be pulled from the front end of the chamber 70. In the illustrated embodiment, this structure corresponds to a flange portion of the front wall 86 of the chamber 70. As illustrated in FIG. 5, the flange portion 86 of the wall engages against the piston 101 of the pump cylinder 92.

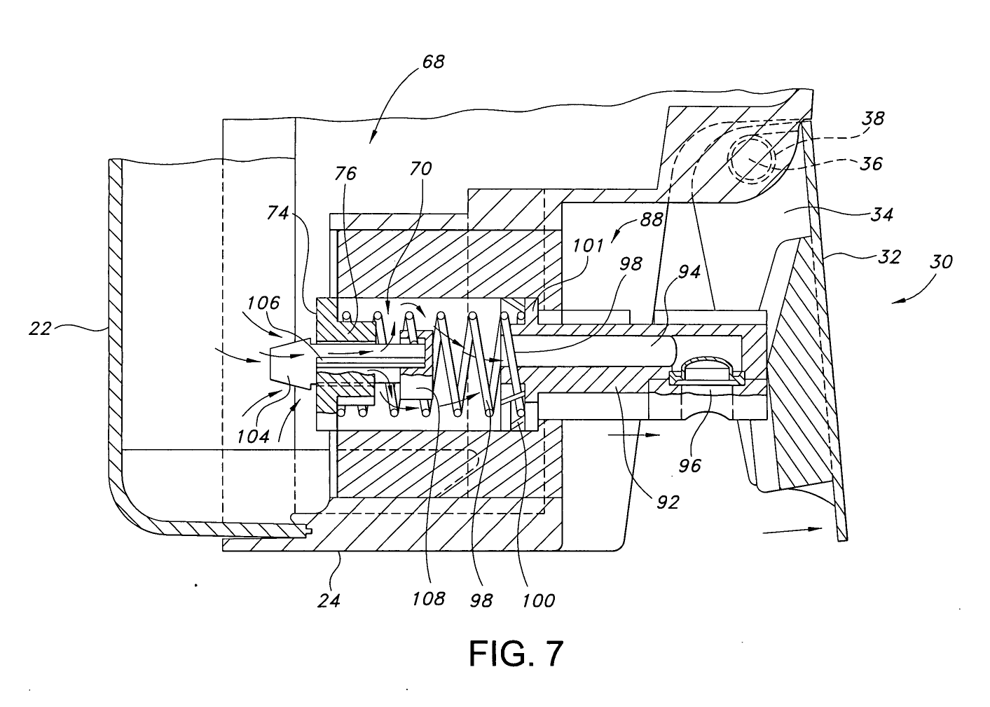

A check valve device 104 is configured with the pump mechanism 88 to ensure that the viscous liquid within the pump chamber 70 is not pushed out of the chamber 70 upon movement of the cylinder 92 within the chamber 70. In the illustrated embodiment, the check valve device 104 is a shuttle type check valve having radially extending arms 106. The shuttle valve is slidably disposed within an opening defined through the end cap 74. The space between the radial arms 106 is open to the reservoir 68 so that the liquid can flow from the reservoir 68 into the pump chamber 70 upon movement of the cylinder to the forward end of the pump chamber 70, as illustrated in FIG. 7. A cap 108 is provided on the forward end of the shuttle valve 104 disposed within the pump chamber 70 to ensure that the opening in the end cap 74 is sealed upon actuation of the pump. The cap 108 seals against the end face of the end cap 74.

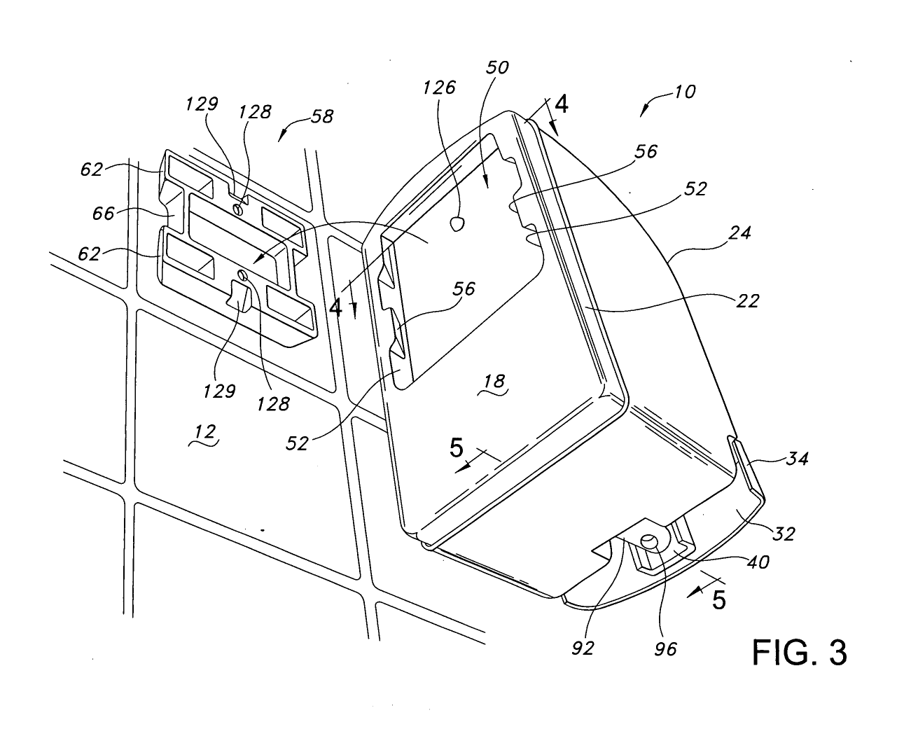

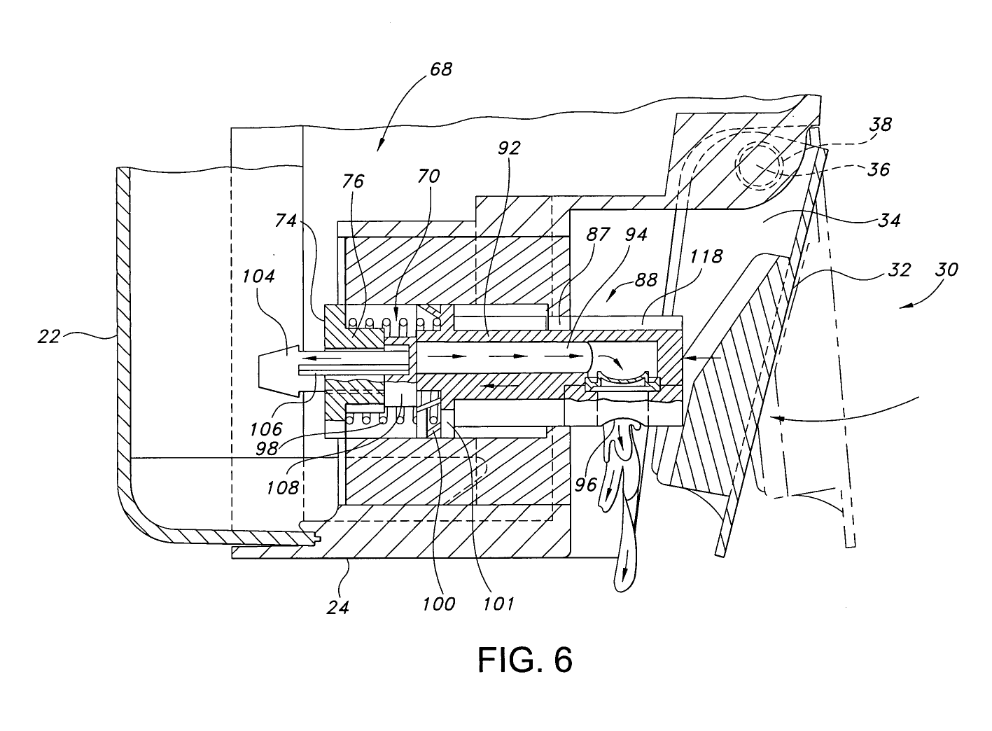

Operation of the pump mechanism 88 is particularly illustrated in FIGS. 6 and 7. To dispense a metered amount of the viscous liquid contained within the reservoir 68, a user actuates the pump mechanism 88 by way of an actuator 30. The actuator 30 may be any member configured to move the pump cylinder 92. The actuator 30 may be defined by a panel member 32 that includes side walls 34 having inwardly disposed protrusions 36 that engage within recesses 38 provided in the sides 16 of the housing 14. A channel member 40 (FIG. 3) may be provided on the inner face of panel member 32 to positively engage against the front end of the pump cylinder 92. A depression 33 (FIG. 1) may be defined in the front face of the panel member 32 to indicate to a user the proper location for depressing the actuator 30. Upon depressing the actuator 30, the pump cylinder 92 is moved rearward within the pump chamber 70. Pressure of the viscous liquid within the chamber 70 forces the shuttle valve 104 to close and the viscous liquid contained within the chamber 70 is directed into the delivery channel 94 defined longitudinally within the pump cylinder 92. The viscous liquid is expelled through the dispensing orifice 96, as particularly illustrated in FIG. 6. Upon release of the actuator 30, the spring 98 forces the pump cylinder to return to the position illustrated in FIG. 7. This action unseats the shuttle valve 104 and draws viscous liquid back into the pump chamber 70, as particularly illustrated in FIG. 7.

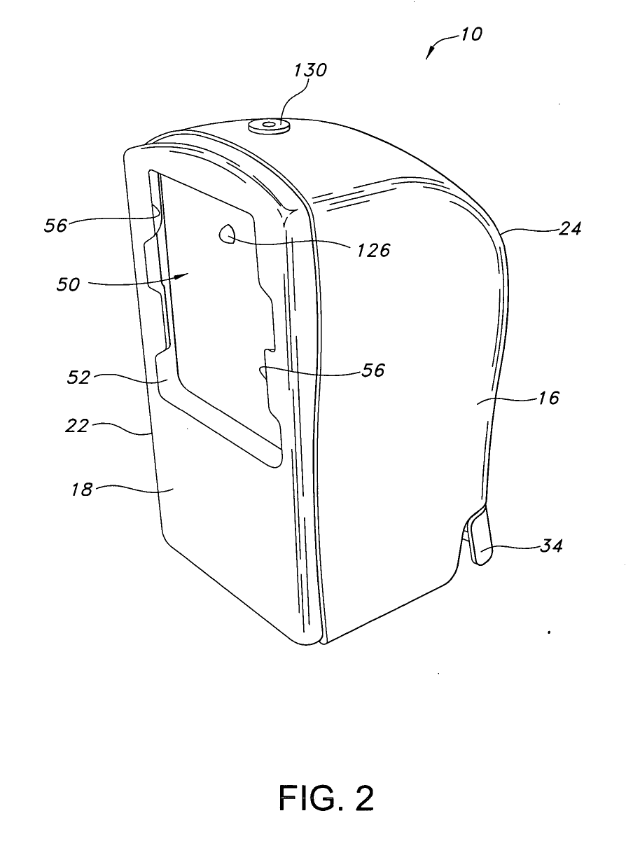

So as not to draw a vacuum within the reservoir 68, the reservoir is vented. This venting may be accomplished by various means. For example, the reservoir 68 could be vented directly through or around the cylinder 92. However, this may not be a desired embodiment since fluid would tend to leak out from around the cylinder. One desirable venting method as illustrated in FIGS. 1 and 2 is to vent the top of the housing 14, for example by way of a conventional vent valve 130 disposed through the top surface of the housing 14. Other desirable vent mechanisms, for example, are disclosed in concurrently filed U.S. patent application Ser. No. ______, Express Mail Number EL 955701965 US, docket number 19372, the entirety of which is incorporated herein by reference.

FIGS. 8a and 8b illustrate a locking characteristic of the pump cylinder 92 that is particularly useful during shipment of the dispensers 10. The pump cylinder 92 may include a longitudinal channel 118 defined in the top thereof. A tab portion 87 of the pump chamber front wall member 86 is disposed within the longitudinal channel 118. In this way, the pump cylinder 92 is prevented from rotating upon actuation and release thereof. A partial circumferential channel 120 is defined in the pump cylinder 92, as particularly illustrated in FIG. 8a. The circumferential channel 120 is defined along the pump cylinder 92 at a location corresponding to the completely depressed or actuated position of the cylinder 92 within the chamber 70, as illustrated in FIG. 6. For shipment of the dispensers 10, the pump cylinder 92 may be depressed and then rotated so that the tab 87 is engaged within the circumferential channel 120, as particularly illustrated in FIG. 8b. In this configuration, the pump cylinder 92 is locked in position and cannot move within the chamber 70 until the pump cylinder is rotated back into the position illustrated in FIG. 8a. This procedure would be accomplished by the maintenance technician prior to mounting the dispenser 10 onto a supporting wall surface. Other lockout devices may be useful for substantially preventing leakage during shipment of the pump. Desirable lockout devices, for example, are disclosed in concurrently filed U.S. patent application Ser. No. ______, Express Mail Number EL 955701815 US, docket number 19371, the entirety of which is incorporated herein by reference.

Referring to FIG. 3, the dispenser 10 according to the invention also includes an integrally formed mounting mechanism configured as an integral component of the housing 14. This mounting mechanism allows the dispenser 10 to be detachably connected with a complementary mounting structure, generally 58, provided on a wall surface 12. As generally shown, the mounting mechanism is defined as an integrally molded feature of the back side 18 of the dispenser 10. In the illustrated embodiment, a recess 50 is molded into the back side 18. The recess 50 is defined by generally vertical side walls 52. Engaging structure is provided along the side walls 52 for engaging against or with complementary structure provided on the wall mounting structure 58, as discussed in greater detail below. In the illustrated embodiment, the engaging structure is defined by angled surfaces 56 defined along the vertical walls 52. The angled surfaces 56 engage against complementary angled surfaces 62 defined on the wall mounting structure 58, as can be generally seen in FIGS. 3 and 10. In the illustrated embodiment, at least two angled surfaces 56 are provided and are separated by a section of the vertical wall 52. The two angled surfaces 56 engage against angled surfaces 62 of the wall mounting structure 58. In order to attach the dispenser 10 to the wall mounting structure 58, the maintenance technician simply positions the dispenser 10 against the wall mounting structure 58 such that the angled surfaces 56 are vertically disposed between the corresponding angled surfaces 62 of the wall mounting structure. Then, the maintenance technician simply slides the dispenser 10 in a vertical direction so that the angled surfaces 56, 62 engage, as generally illustrated in FIG. 10. In this interlocking configuration, the dispenser cannot be pulled away from the wall mounting structure 58. The double angled surface 56 configuration provided on each vertical wall 52 is particularly useful in that it provides an increased interlocking surface area of angled surfaces with relatively little vertical movement required between the dispenser 10 and the wall mounting structure 58 as compared to a single angled surface 56 having the same longitudinal surface area.

The wall mounting structure 58 may comprise any manner of suitable attaching structure. In the illustrated embodiment, the wall mounting structure 58 is defined by a plate member 64 that is attached to the wall surface 12, for example by screws, adhesives, or the like. The wall mounting structure 58 serves simply to provide an interlocking engagement device for the dispenser 10. It should be appreciated that any manner of interlocking engaging configurations may be provided for detachably connecting the dispenser 10 to complementary wall structure provided on a supporting wall. A desirable feature of the invention is that the entire dispenser 10 is disposable and, thus, relatively simple yet reliable engagement devices are preferred. It has been found that the double angled surface configuration as illustrated and described herein is particularly useful in this regard.

Once the dispenser 10 has been properly located on the wall mounting structure 58, it is desirable to include a positioning device to indicate to the technician that the dispenser 10 has been properly positioned. The positioning device may comprise a protrusion 126 extending from the back side 18 of the housing within the recess 50. The protrusion 126 slides up a ramp surface 129 defined in the mounting structure 58 and snaps into a correspondingly sized divot 128 disposed adjacent to the ramp surface 129.

It should be appreciated that dispensers according to the invention are not limited in their size so long as the mounting mechanism between the housing and wall mounting structure is structurally sufficient to support the weight of the filled housing.

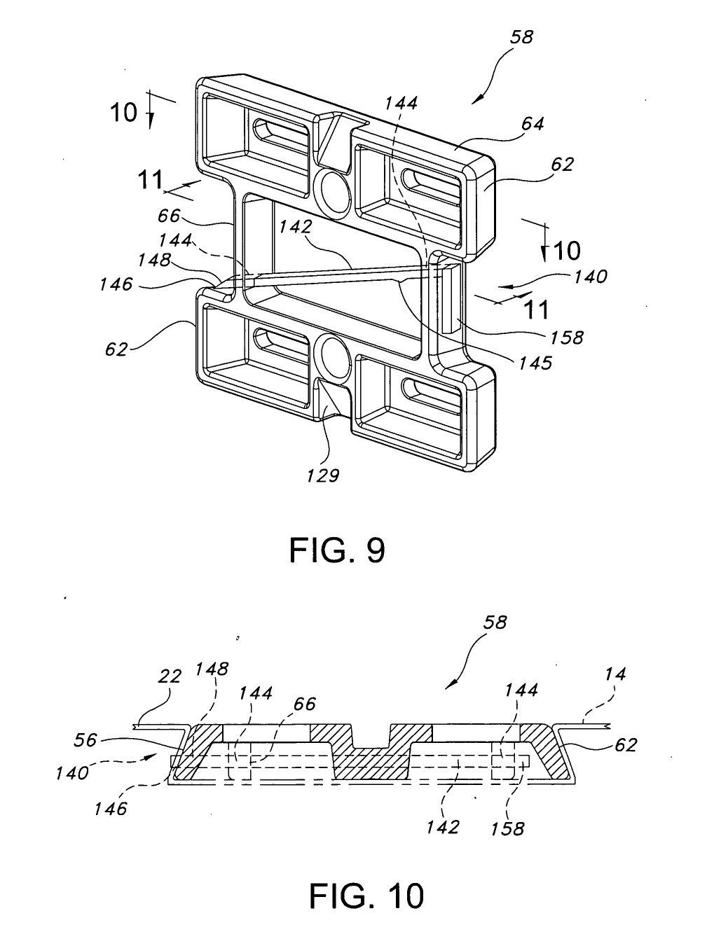

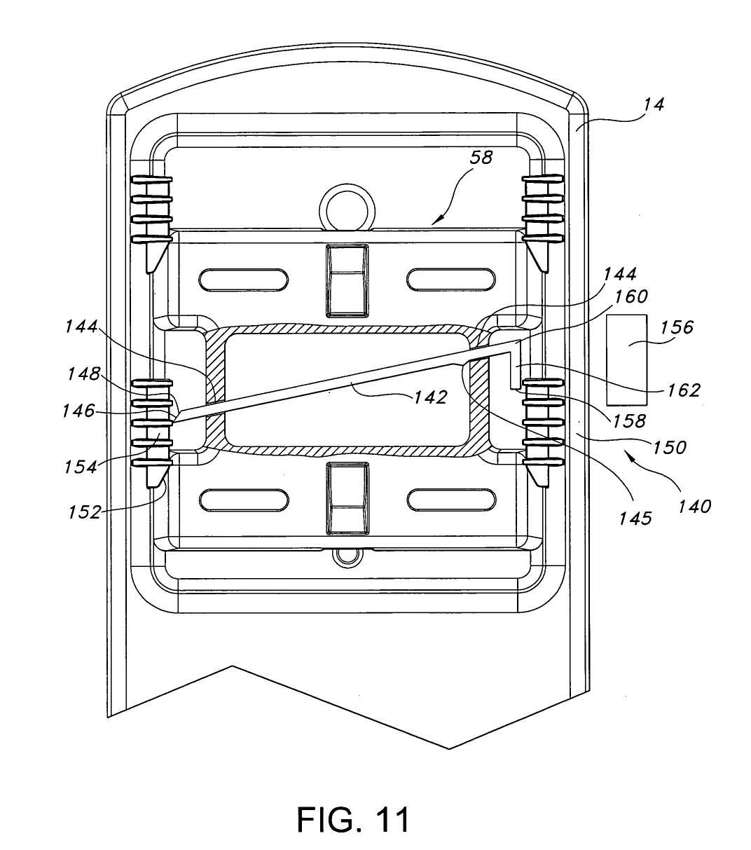

Referring to FIGS. 9-12, the wall mounting structure 58 has an internal, two-position locking mechanism 140 that is capable of resisting or preventing removal of the housing by unauthorized persons. By “internal” is meant that the locking mechanism 140 and its method of activation are not obviously visible after installation of the dispenser housing 14. By “two-position” is meant that the locking mechanism 140 can be moved through proper activation between an “open” position which allows removal of the housing and a “locked” position which prevents removal of the dispenser housing 14. In the illustrated embodiment, the locking mechanism 140 comprises a slidable pin 142 positioned within one or more openings 144 defined by the wall mounting structure 58. Desirably, the one or more openings 144 are defined by at least one vertical wall member 66 of the wall mounting structure 58. In the illustrated embodiment, the pin 142 comprises a ferrous metal so that the pin is generally attracted to magnets. The pin 142 has a first end 146 having a chamfered surface 148. FIG. 11 depicts the “open” position of the pin 142, i.e., the position of the pin at which the dispenser housing 14 can be moved into or out of its final mounting position.

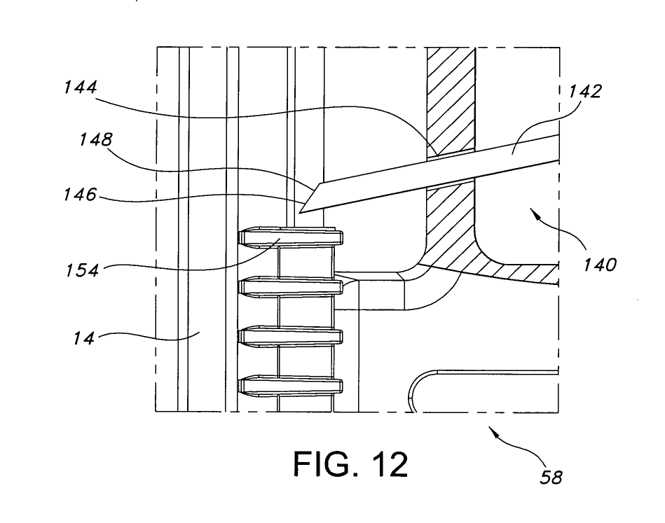

During installation of the dispenser housing 14, i.e., as the dispenser housing is lowered toward the final installed position, the chamfered surface 148 of the pin 142 may contact a chamfered surface 152 below a protrusion 154. Contact between the two chamfered surfaces 148,152 causes the pin 142 to slide upwardly within the openings 144 towards the “open” position where the pin does not impede the installation of the dispenser housing 14 onto the wall mounting structure 58. When the dispenser housing 14 reaches the final installed position, the pin 142 slides downwardly within the openings 144 to the “locked” position depicted in FIG. 12. In the “locked” position, the first end 146 of the pin 142 is positioned above the protrusion 154. The position of the openings 144 is desirably selected such that the force of gravity will cause the pin 142 to fall to its most downward and outward position, i.e., the “locked” position, after the first end 146 clears the protrusion 154. The pin 142 is now in position to prevent the removal of the dispenser housing 14 from the wall mounting structure 58. Any unauthorized and/or uninformed attempt to remove the dispenser housing 14 from the wall mounting structure 58 will be impeded by the contact between the first end 146 of the pin 142 and the protrusion 154.

To remove the dispenser housing 14 from the wall mounting structure 58, a magnet 156 is placed adjacent a side wall 150 of the dispenser housing 14 near a second end 158 of the pin 142. The magnetic attraction between the magnet 156 and the pin 142 causes the pin to slide away from the protrusion 154 and towards the “open” position. The pin 142 has a bend 160 that prevents the pin from sliding out of the openings 144. To increase the magnetic attraction between the magnet 156 and the pin 142, a segment 162 of the pin is provided adjacent the bend 160, the segment extending adjacent the wall mounting structure 58. The size of the magnet 156 required to generate enough magnetic force necessary to move the pin is readily determined by one skilled in the art.

Desirably, the pin 142 further comprises a projection 145. The projection 145 serves to prevent the pin 142 from being pulled too far by the magnet 158 in the direction opposite the first end 146, and thus remain securely within the openings 144. Additionally, the magnet may be used to slide the pin towards the “open” position during the installation of the dispenser housing. Thus is provided a simple apparatus and easy method for locking the dispenser housing 14 to the wall mounting structure 58 while providing maintenance personnel simple and easy removal of the dispenser housing.

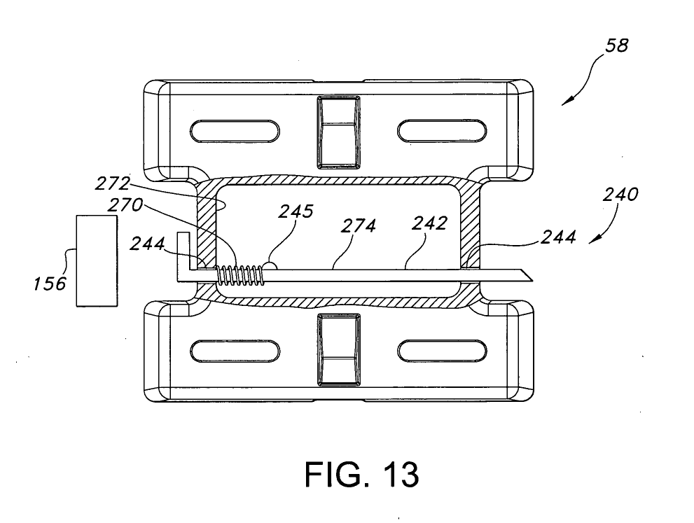

FIG. 13 depicts another embodiment of a two-position locking mechanism. The two-position locking mechanism 240 includes a pin 242 slidingly positioned horizontally within first and second openings 244 defined within the wall mounting structure 58. The pin 242 is resiliently biased towards a “locked” position. While many configurations for biasing the pin 242 may be envisioned, as one example a spring 270 is compressed between an inside surface 272 of the wall mounting structure 58 and a projection 245 attached to a side surface 274 of the pin. FIG. 13 depicts a coil spring being used to resiliently bias the pin 242 towards the locking position. However, other types of springs may be utilized as well, such as, for example, leaf springs attached to the wall mounting structure 58, and so forth. As described above, a magnet 156 can be used to overcome the force of the spring 270 and move the pin 242 towards an “unlocked” position to allow the dispenser housing 14 to be mounted to or removed from the wall mounting structure 58.

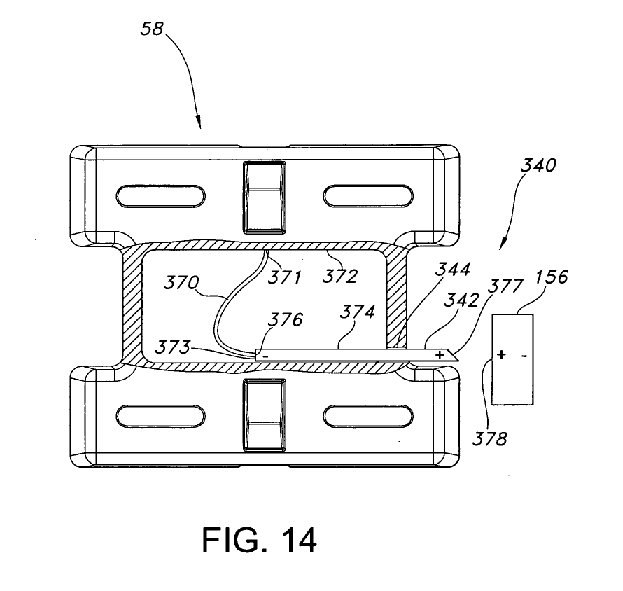

FIG. 14 depicts a further embodiment of a two-position locking mechanism. The two-position locking mechanism 340 includes a magnetic locking pin 342 slidingly positioned within at least one opening 344 defined within the wall mounting structure 58. The pin 342 is resiliently biased towards a “locked” position. While many configurations for biasing the pin 342 may be envisioned, as one example a leaf spring 370 urges the pin towards the “locked” position. A first end 371 of the leaf spring 370 is attached to an inside surface 372 of the wall mounting structure 58 and a second end 373 of the leaf spring 370 contacts and urges the pin 342. Desirably, the second end 373 of the leaf spring 370 is attached to the surface 374 of the pin 342. Even more desirably the second end 373 of the leaf spring 370 is attached to the first end 376 of the pin 342. Other types of springs and spring arrangements may be utilized as well, such as, for example, the coil spring arrangement depicted in FIG. 13 and described above, and so forth. Similar to as described above, a magnet 156 can be used to overcome the force of the spring 370 and move the pin 342 towards an “unlocked” position to allow the dispenser housing 14 to be mounted to or removed from the wall mounting structure 58. However, because the pin 342 is magnetized, a magnet 156 having a first end 378 of opposite polarity to the second end 377 of the pin is used to overcome the force of the spring 370 against the pin. Simply placing the first end 378 of the magnet 156 of opposite polarity adjacent the side of the dispenser near the pin 342 will repel the pin to the “unlocked” position and allow installation or removal of the dispenser.

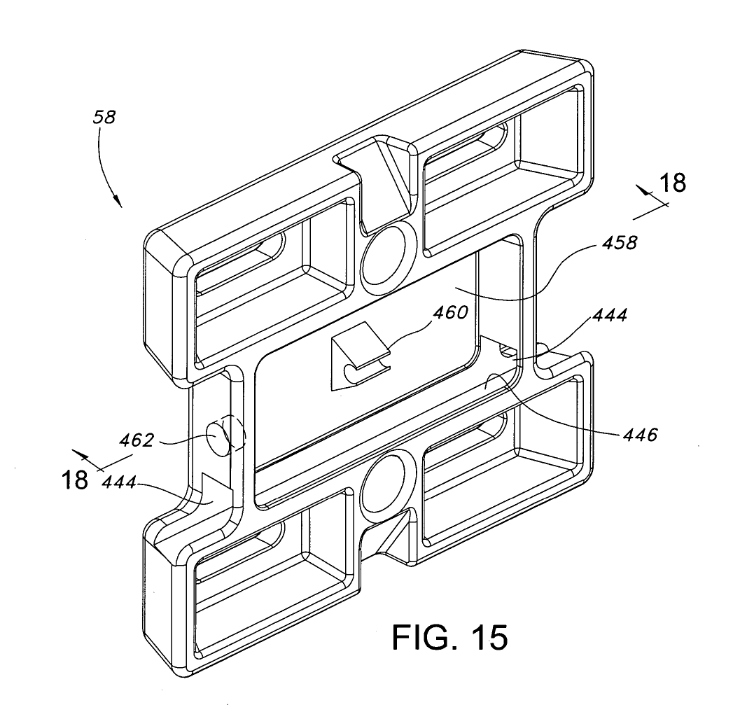

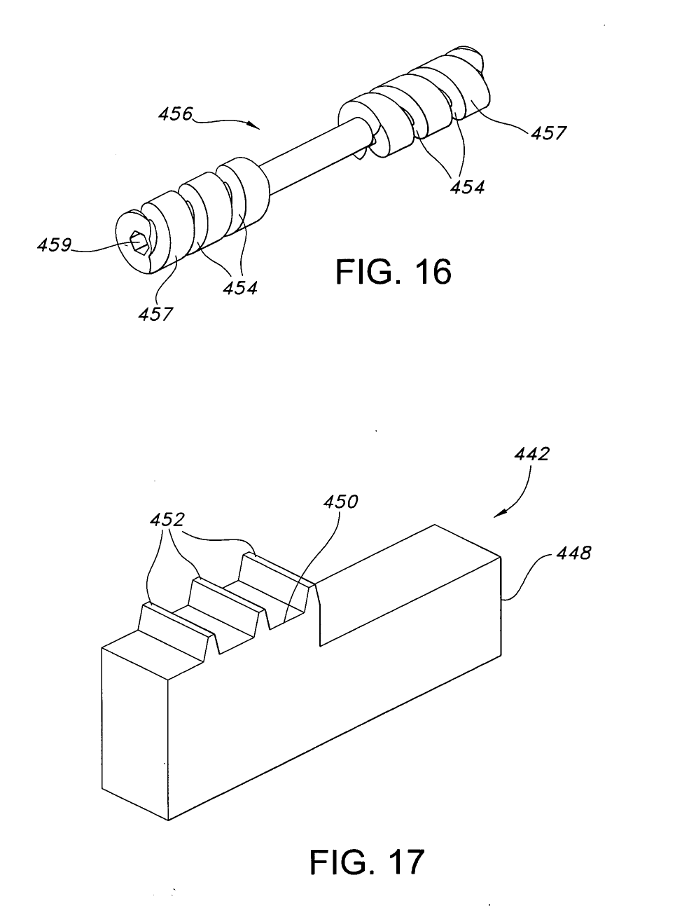

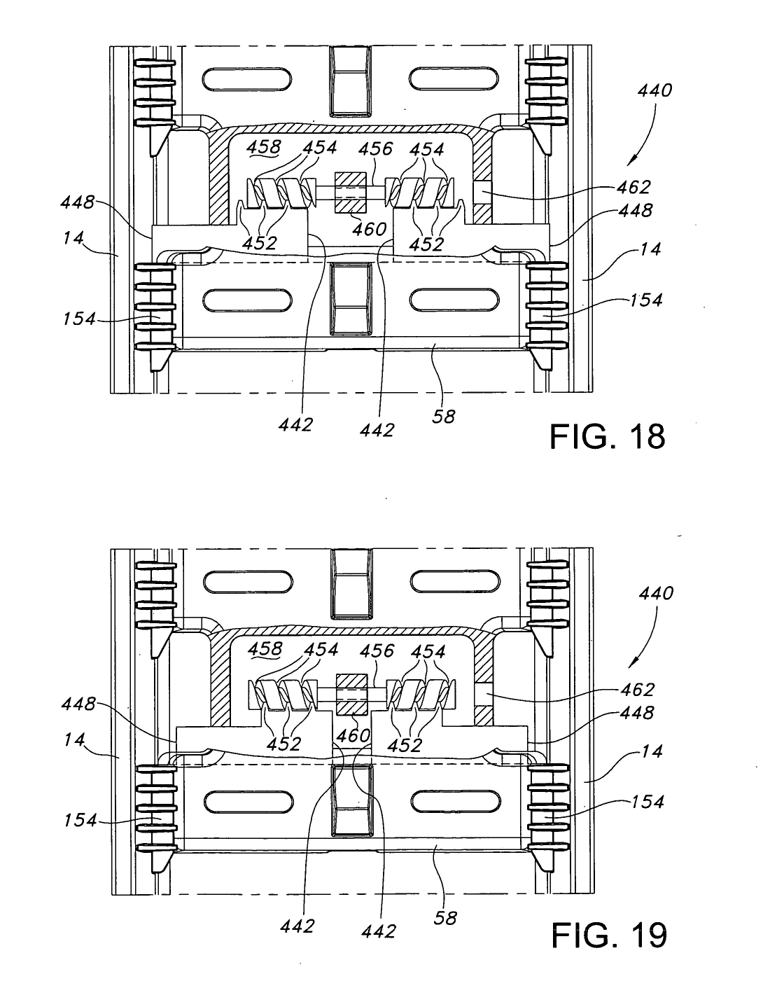

FIGS. 15-19 depict an even further embodiment of a two-position locking mechanism. The two-position locking mechanism 440 comprises at least one slidable gear rack 442. Desirably, the two-position locking mechanism 440 comprises two opposed slidable gear racks 442 as depicted in FIGS. 18 and 19. The slidable gear racks 442 are positioned within openings 444 defined within the wall mounting structure 58. Desirably, the slidable gear racks 442 are supported by a surface 446 on the wall mounting structure 58. The slidable gear rack is capable of sliding upon the surface 446 and through the openings 444 between a “locked” position as depicted in FIG. 18 and an “unlocked” position depicted in FIG. 19. At the locked position, a first end 448 of the slidable gear rack 442 extends past the protrusion 154 on the dispenser housing 14 such that any attempt to remove the dispenser housing from the wall mounting structure 58 will cause the first end 448 of the slidable gear rack 442 to contact the protrusion 154 on the dispenser housing 14 and prevent removal of the dispenser housing. At the unlocked position, the first end 448 of the slidable gear rack 442 is retracted within the wall mounting structure 58 and does not impeded removal of the dispenser housing 14.

A surface 450 of the slidable gear rack 442 comprises one or more gear teeth 452. Desirably, the surface 450 of the slidable gear rack 442 comprises at least three gear teeth 452. The spacing of the gear teeth 452 complements the spacing of threads 454 on a pinion 456 having first and second ends 457. The pinion 456 is rotatably mounted to a surface 458 on the wall mounting structure 58. As one example, the pinion 456 may be mounted to a partial bushing 460 attached to the surface 458 on the wall mounting structure 58. If only one slidable gear rack 442 is used, then only the first end 457 of the pinion need be threaded. If two slidable gear racks 442 are used, then both the first end and second ends 457 are threaded, however, the thread handedness or direction at the first end is reversed compared to the handedness at the second end such that the slidable gear racks 442 will travel in opposite directions when the pinion 456 is rotated. For example, when the pinion 456 is rotated in one direction, both slidable gear racks 442 will slide away from each other and towards the “locked” position. When the pinion 456 is rotated in the other direction, both slidable gear racks 442 will slide towards each other and towards the “unlocked” position. Desirably, the pitch of the threads 454 is such that an about one quarter turn of the pinion 456 results in the slidable gear racks 442 moving from the “locked” position to the “unlocked” position and vice versa.

One end 457 of the pinion 456 defines an opening 459 for engagement with a tool (not shown) that can be used to rotate the pinion. The opening 459 may have one of many different shapes depending upon the type of tool used. For example, the opening 459 may be shaped to accept a screwdriver, a hexagonal wrench, and so forth. Access to the end 457 is provided through an opening 462 defined within the wall mounting structure 58. A corresponding opening (not shown) may be defined within the dispenser housing 14 to allow access of the tool to the shaped end 457 of the pinion 456.

It should be appreciated by those skilled in the art that various modification or variations can be made in the invention without departing from the scope and spirit of the invention. It is intended that the invention include such modifications and variations as come within the scope of the appended claims and their equivalents.

1. A mounting bracket for mounting a liquid dispenser housing to a wall, the bracket comprising:
a plate member comprising a first substantially vertical side wall and a second substantially vertical side wall, each substantially vertical side wall comprising at least one angled surface for engaging against complementary angled surfaces on the liquid dispenser housing; and
a two-position locking mechanism comprising a locking member slidingly engaged within at least one opening defined within the plate member, wherein the locking member is capable of sliding to a first position at which an end portion of the locking member extends beyond the first vertical side wall to interfere with removal of the liquid dispenser housing from the mounting bracket, and wherein the locking member is capable of sliding to a second position at which the liquid dispenser housing may be removed from the mounting bracket.

2. The mounting bracket of claim 1 wherein the locking member comprises a pin.

3. The mounting bracket of claim 2 wherein the pin comprises a first portion extending substantially parallel to the second vertical side wall.

4. The mounting bracket of claim 3 wherein the pin comprises a second portion extending substantially perpendicular to the second vertical side wall.

5. The mounting bracket of claim 3 wherein the pin comprises a second portion extending at an angle with respect to the second vertical side wall.

6. The mounting bracket of claim 1 wherein the locking member comprises a ferrous material.

7. The mounting bracket of claim 1 wherein the locking member comprises a magnet.

8. The mounting bracket of claim 1, wherein the locking mechanism is magnetically activated.

9. The mounting bracket of claim 1 further comprising a means for urging the locking member towards the first position.

10. The mounting bracket of claim 9 wherein the means for urging comprises a spring.

11. The mounting bracket of claim 1 wherein the end portion of the locking member comprises a chamfered surface.

12. The mounting bracket of claim 1 further comprising a pinion rotatably attached to a surface of the plate member, the pinion comprising a first end having a first set of circumferential angled threads engaged to at least one tooth on a surface of the locking member, wherein rotation of the pinion in a first direction slides the locking member toward the first position, and wherein rotation of the pinion in a second direction slides the locking member toward the second position.

13. The mounting bracket of claim 12 wherein the pinion is rotatably supported within a bushing attached to a surface of the plate member.

14. The mounting bracket of claim 12 further comprising a second locking member comprising an at least one tooth engaged to a second set of circumferential angled threads upon a second end of the pinion, wherein rotation of the pinion in the first direction slides the locking members away from one another to lock the dispenser housing to the mounting bracket, and wherein rotation of the pinion in the second opposite direction slides the locking members towards each other to unlock the dispenser housing from the mounting bracket.

15. A self contained viscous liquid dispenser, comprising:
a housing;
an internal liquid reservoir defined by the housing;
a dispensing pump mechanism disposed at least partially within the reservoir and having a delivery end extending out of the reservoir;
a mounting mechanism configured as an integral component of the housing, the mounting mechanism comprising angled surfaces detachably connectable with a complementary mounting structure on a wall surface; the complementary mounting structure comprising:
a plate member comprising a first substantially vertical side wall and a second substantially vertical side wall, each substantially vertical side wall comprising at least one angled surface for engaging against complementary angled surfaces on the liquid dispenser housing; and
a two-position locking mechanism comprising a locking member slidingly engaged within at least one opening defined within the plate member, wherein the locking member is capable of sliding to a first position at which an end portion of the locking member extends beyond the first vertical side wall to interfere with removal of the liquid dispenser housing from the mounting structure, and wherein the locking member is capable of sliding to a second position at which the liquid dispenser housing may be removed from the mounting structure.

16. The dispenser as in claim 15, wherein the housing is slidable in a generally vertical direction onto the mounting structure, the angled surfaces sliding into engagement with the complementary angled surfaces on the mounting structure such that the housing cannot be pulled away from the mounting structure.

17. A disposable viscous liquid dispenser, comprising:
a housing defining an internal integral liquid reservoir, the housing further comprising a back side configured for placement against a supporting wall surface;
a dispensing pump mechanism disposed at least partially within the reservoir and comprising an operable delivery end for dispensing the viscous liquid from the housing;
a mounting mechanism formed integral with the back side, the mounting mechanism comprising engagement surfaces configured to releasably interlock with complementary structure of a wall mounting member provided on a supporting wall so that the housing cannot be pulled away from the supporting wall;
a sliding locking member slidingly positioned within at least one track defined within the wall mounting member;
a means for resiliently biasing the sliding locking member towards a locking position; and
a means for moving the sliding locking member towards a position at which the sliding locking member will not prevent the removal or installation of the housing.

18. A disposable liquid soap dispenser, comprising:
a housing defining an internal integral liquid soap reservoir, the housing further comprising a back side configured for placement against a supporting wall surface;
a dispensing pump mechanism disposed at least partially within the reservoir and comprising an operable delivery end for dispensing liquid soap from the housing;
a mounting mechanism formed integral with the back side, the mounting mechanism comprising engagement surfaces configured to releasably interlock with complementary structure of a wall mounting member provided on a supporting wall so that the housing cannot be pulled away from the supporting wall, the mounting mechanism comprising a recess defined in the back side, the recess further comprising at least two vertical side walls having at least one angled surface disposed on each of the vertical side walls, the housing being slidable in a generally vertical direction onto the wall mounting member, the angled surfaces sliding into engagement with complementary angled surfaces on the wall mounting member; and
a mounting bracket locking mechanism comprising a locking member slidingly engaged by the mounting structure, wherein the locking member is capable of sliding to a locking position at which a portion of the locking member is positioned so as to interfere with removal of the housing from the mounting structure, and wherein the locking member is capable of sliding to an unlocked position to enable removal of the housing from the mounting structure.

19. The dispenser of claim 18, further comprising a protrusion disposed on the back side of the housing, the protrusion engageable in a complementary divot defined in the wall mounting structure.

20. A method of attaching a liquid dispenser to a wall mounting structure comprising the steps of:
placing a magnet adjacent a locking mechanism attached to the wall mounting structure to slide a locking member to a central location within the wall mounting structure;
engaging the dispenser to the wall mounting structure;
removing the magnet to allow the locking member to slide to a locking location where the locking member restricts removal of the dispenser from the wall mounting structure.

21. A method of removing a liquid dispenser from a wall mounting structure comprising the steps of:
placing a magnet adjacent a locking mechanism inside the wall mounting structure to deactivate the locking mechanism; and
disengaging the dispenser from the wall mounting structure.
